(19) United States
(12) Patent Application Publication
(10) Pub. No.: US 2009/0244002 A1
(43) Pub. Date: Oct. 1, 2009

(54) Method, Device and Program for Controlling Display, and Printing Device

(75) Inventor: Hiroyuki TSUJI, Kagoshima-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/404,980

(22) Filed: Mar. 16, 2009

(30) Foreign Application Priority Data
Mar. 25, 2008 (JP) 2008-079358

(51) Int. Cl. G09G 5/00; G06K 9/46; G06F 3/12

(52) U.S. Cl. 345/156; 382/195; 358/1.1; 715/810

(57) ABSTRACT

A display control method for displaying a screen which receives a user-selected option from a predetermined option group through predetermined option presentation, the method includes: detecting a face image area which at least includes a user face in an image area; and determining an initial position of the predetermined option presentation in accordance with the face image area.

### BACKGROUND

1. Technical Field

The present invention relates to a method, device and program for controlling a display, and a printing device. More particularly, the invention relates to displaying a selection position.

2. Related Art

A well-known display control device with a screen displays a predetermined option group from which an option is to be selected according to instructions displayed thereon. In a terminal unit such as an automated teller machine (ATM), for example, languages for display and sound guidance have been determined in advance in accordance with a location of the terminal unit or other factors. With the advent of globalization, such a display control device has recently employed a language selection screen on which user-selected language is presented after the user operated a touch panel or a button in order to provide a plurality of languages irrespective of location of the device. Such a device suffers, however, from a problem of requiring longer time and increased operation effort in selecting the language as available language options become wider.

To address such a problem, JP-A-2005-275935 discloses a method of providing a user interface (UI) with improved convenience without utilizing user information stored in an ID card, a credit card and an account book. The method includes estimating user attribute (e.g., race, sex and generation) from a photographed face image of the user and presenting several candidate languages in accordance with the user race based on the estimated result. In this manner, an operation effort of the user to be made in selecting the language is reduced as compared to a case where all the languages are presented as candidates.

JP-A-2007-94840 discloses determining user race based on a feature quantity of a face image extracted from a still picture obtained from image data.

JP-A-2006-146413 discloses, in database retrieval from an input face image, reducing options to be retrieved based on user attribute such as sex, age (i.e., generation), height and race.

The user attribute, however, cannot always be correctly estimated and thus required options may disappear when the options are reduced based on the estimated result.

### SUMMARY

An advantage of some aspects of the invention is to provide a method, device and program for controlling a display on which a user easily selects an option from a predetermined option group through a predetermined option presentation. Another advantage of some aspects of the invention is to provide a printing device incorporating the same.

An aspect of the invention is a display control method for displaying a screen which receives a user-selected option from a predetermined option group through predetermined option presentation, the method includes: detecting a face image area which at least includes a user face in an image area; and determining an initial position of the predetermined option presentation in accordance with the face image area.

In this manner, a user interface with improved convenience can be provided on which the user may easily select an option from the predetermined option group without reducing options in the predetermined option group.

In determining the initial position of the predetermined option presentation, an attribute of the user may preferably be estimated from the face image area and the initial position may preferably be determined based on the estimated attribute such that the predetermined option presentation is operated by the user through an option-selecting unit with the minimum operating effect in selection of an option. In this manner, a required option can be suitably selected by the user with less operating effort without reducing the options.

In determining the initial position of the predetermined option presentation, the initial position may preferably be determined based on the estimated attribute such that the operation effort of the user is reduced as compared to a case in which a given initial position is displayed when no face image area has been detected. In this manner, the required option can be selected reliably with less operating effort.

In determining the initial position of the predetermined option presentation, one or more estimated options including predetermined options that may possibly be selected by the user may preferably be stored for each attribute. If a single estimated option exists, a position of an option corresponding to the estimated option may preferably be determined as the initial position. If a plurality of the estimated options exists, a position of an option from which those options corresponding to the estimated options can be accessed with the minimum operation effort may preferably be determined as the initial position. In this manner, the initial position is determined in a suitable manner.

The estimated options by learning control may preferably be updated based on actually selected options. In this manner, the initial position is determined in a more suitable manner.

The image may preferably be a photographed image of the user face. In this manner, the initial position corresponding to the user who is selecting the options can be determined in a suitable manner.

The user attribute may preferably include information on race, sex and generation of the user included in the face image area. In this manner, a user interface with improved convenience can be provided for displaying option groups according to the user race, sex and generation without reducing the options.

The technical idea of the invention is embodied not only in a display control method, but also in a display control device. That is, the invention may also be embodied as a display control device which includes units corresponding to the processes executed by the display control method. If the display control device is adapted to read programs to achieve these units, the technical idea of the invention may also be embodied in programs for executing functions corresponding to these units, and in various recording media storing the programs. The display control device according to the invention is not limited to a single device, but may also be distributed to a plurality of devices. The units of the display control device of the invention may alternatively be incorporated in a printing device, such as a printer.

### BRIEF DESCRIPTION OF THE DRAWINGS

FIG. 1 is a block diagram showing a hardware configuration of a display control device.

FIG. 2 shows an exemplary menu selection screen.

FIG. 3 is a block diagram showing a software configuration of a display control device.

FIG. 4 shows an exemplary result of facial feature detection.

FIGS. 5A and 5B show exemplary attributes to be specified.

FIG. 6 shows an exemplary initial position in a language selection screen.

FIG. 7 is a flowchart of a control routine for a screen display process.

FIG. 8 is an exemplary user interface screen.

FIG. 9 is an exemplary menu selection screen for time zones.

FIG. 10 is an exemplary of a menu selection screen for hospital departments.

FIG. 11 is an exemplary menu selection screen for book categories.

### DESCRIPTION OF EXEMPLARY EMBODIMENTS

Referring now to the drawings, an embodiment of the invention will be described regarding (1) schematic configuration of a display control device, (2) routine for screen display operation and (3) modified embodiment.

### (1) Schematic Configuration of Display Control Device

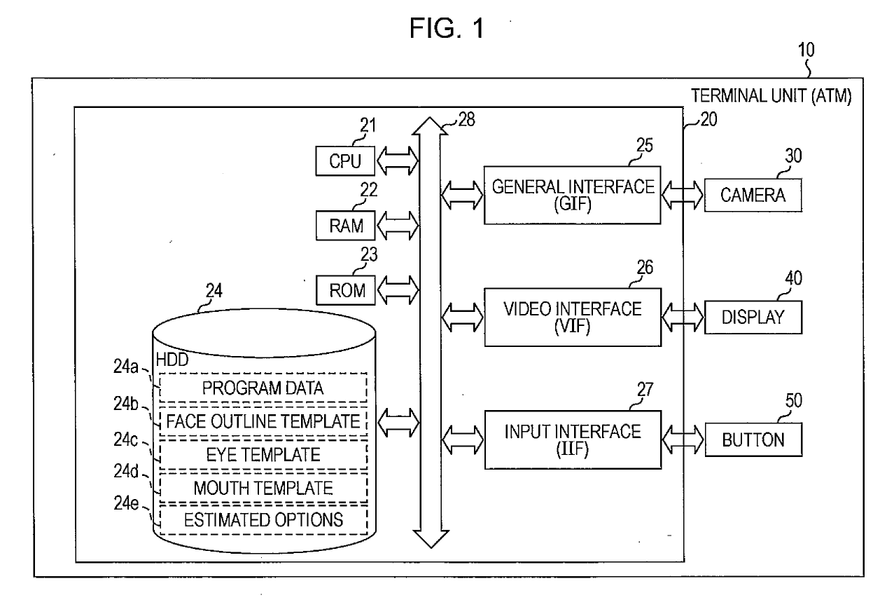

FIG. 1 shows a configuration of a terminal unit which embodies a display control device according to an embodiment of the invention. As shown in FIG. 1, a terminal unit 10, which may be an ATM, includes a computer 20, a camera 30, a display 40 and a button 50.

The computer 20 includes a CPU 21, a RAM 22, a ROM 23, a hard disk drive (HDD) 24, a general interface (GIF) 25, a video interface (VIF) 26, an input interface (IIF) 27 and a bus 28. The bus 28 provides data communication among the components 21 to 27 of the computer 20. Communication on the bus 28 is controlled by, for example, an unillustrated chip set.

The HDD 24 stores program data 24a used for executing the programs including an operating system (OS). The CPU 21 operates in accordance with the program data 24a while developing the program data 24a in the RAM 22. Many face outline templates 24b, eye templates 24c and mouth templates 24d used for pattern matching, which will be described later, are stored in the HDD 24.

The GIF 25 connects the computer 20 to the camera 30 and provides an interface for inputting image data from the camera 30. The VIF 26 connects the computer 20 to the display 40 and provides an interface for displaying images on the display 40. The IIF 27 connects the computer 20 to the button 50 and provides an interface on which the computer 20 obtains signals input from the button 50.

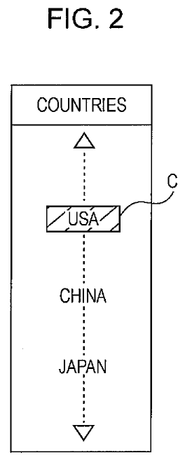

The camera 30 is used for photographing a face image of a user operating the terminal unit 10. The camera 30 includes a charge-coupled device (CCD) sensor and a complementary metal-oxide semiconductor (CMOS) sensor. The display 40 is a display unit on which a predetermined user interface screen (UI screen) is displayed. On the UI screen, a screen for receiving a user-selected option from a predetermined option group through predetermined option presentation, namely a menu selection screen on which a user can select an option from a predetermined option group, is displayed. The button 50 is an operation button which receives user operations. For example, the button 50 functions as an option-selecting unit for a user to move an indicator C which indicates a predetermined option presentation while selecting an option from a predetermined option group on a menu selection screen as shown in FIG. 2. The indicator C indicates an option to be selected from a predetermined option group in a well-known interface for menu selection in which preselected options are presented. The indicator C may indicate a selected option by highlighting as shown in FIG. 2 or an arrow or cursor disposed near the option. A well-known scroll bar, check box, mouse pointer may also represent the indicator C.

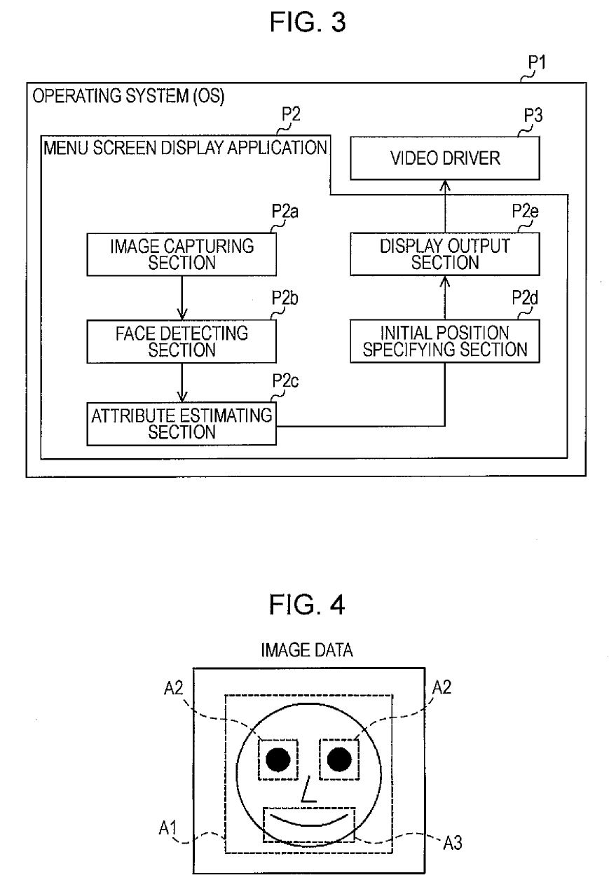

FIG. 3 shows a software configuration of programs to be executed in the computer 20. As shown in FIG. 3, an operating system (OS) P1, a menu screen display application P2 and a video driver P3 are in operation. The OS P1 provides an interface among the programs. The video driver P3 executes processes for controlling the display 40. The menu screen display application P2 includes an image capturing section P2a, a face detecting section P2b, an attribute estimating section P2c, an initial position specifying section P2d, and a display output section P2e.

The image capturing section P2a has a function of a face image capturing unit for obtaining, with the camera 30, face image data of a user operating the terminal unit 10. The image capturing section P2a may be always activated to photograph the user face, may be activated when an unillustrated sensor detects a user coming to use the terminal unit 10 or may be activated when the terminal unit 10 is operated by the user.

The face detecting section P2b has a function of a face detecting unit for detecting a face image area which at least includes a user face from the face image data of the user obtained by the image capturing section P2a. In particular, the face detecting section P2b detects facial features from the face image data. In the present embodiment, the face outline templates 24b, eye templates 24c and mouth templates 24d are used to detect a face outline, eyes and mouth. Here, multiple face outline templates 24b, eye templates 24c and mouth templates 24d are used to detect the face image area from the face image data through well-known pattern matching.

For example, the face detecting section P2b compares the multiple face outline templates 24b, eye templates 24c and mouth templates 24d with images of rectangular comparison areas formed in the image included in the face image data. Those comparison areas having high similarity with the face outline templates 24b are determined to include the facial features. Positions and sizes of the comparison areas may be changed to sequentially determine the face image areas included in the face image data. Sizes of the facial features may be detected from the sizes of the comparison areas having high similarity with the face outline templates 24b, eye templates 24c and mouth templates 24d. The face outline templates 24b, eye templates 24c and mouth templates 24d are each rectangular image data for detecting positions and sizes of rectangular images including the facial features.

FIG. 4 shows an exemplary result of facial feature detection. A rectangular area A1 including a face outline corresponding to the face image area in the image included in the face image data is specified. The rectangular area A1 defines size and position of the face image area. A rectangular area A2 including both eyes and a rectangular area A3 including a mouth are then detected. Whether the face image area has been detected is determined by whether at least one rectangular area Al including the face outline is detected. Alternatively, whether one face image area has been detected may be determined by whether two rectangular areas A2 for the eyes and a rectangular area A3 for the mouth are detected in appropriate positions as face features near the rectangular area A1 for the face outline. The face detecting section P2b may detect the face image area by any other known method.

The attribute estimating section P2c has a function of an attribute estimating unit for estimating a user attribute from the face image area detected by the face detecting section P2b. In particular, the attribute estimating section P2c first places a plurality of feature points in the face image area detected by the face detecting section P2b and quantizes the feature points to obtain a feature quantity of the face image area. For example, the attribute estimating section P2c converts the detected face image area into a gray scale image, which is then subject to angle normalization and size normalization based on a positional relationship of the features of the face image area detected by the face detecting section P2b. These processes are collectively called pre-processing. The attribute estimating section P2c determines positions of the feature points based on the positions of the features in the detected face image area. The attribute estimating section P2c then obtains periodicity and directionality of a contrast characteristic near the feature points as the feature quantity through well-known Gabor wavelet transformation of each feature point and subsequent convolution of a plurality of Gabor filters with different resolutions and directions. The attribute estimating section P2c then estimates the user attribute corresponding to the face image area detected by the face detecting section P2b based on the feature quantity of each feature point. For example, the attribute estimating section P2c estimates the user attribute by inputting feature quantity of each feature point to a pattern recognizer, which has been subject to a learning process. The pattern recognizer may be a well-known support vector machine. The attribute may include user information such as race, age and sex, each of which will be estimated.

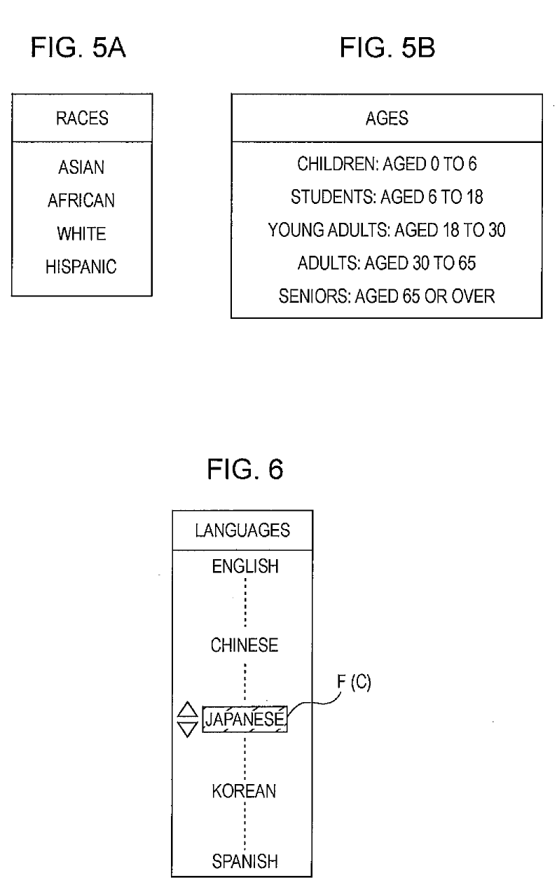

FIGS. 5A and 5B illustrate attribute data regarding race and age, respectively, which will be specified. The HDD 24 stores estimated options 24e for each attribute data. The estimated options 24e include options which may possibly be selected by the user. For example, the estimated options for the language may include: Japanese, Korean, Chinese, Thai, Mongolian, Laotian, Vietnamese and Arabic languages for Asian users; Afrikaans, Sango, Tswana and English for African users; English, German, French, Italian, Russian and Dutch stored for white users; and Spanish and English for Hispanic users.

The initial position specifying section P2d has a function of an initial position specifying unit for specifying an initial position F of the indicator C based on the attribute estimated by the attribute estimating section P2c. The initial position F is determined such that an operation effort (i.e., an operation amount) of the user operating the indicator C for selecting a desired option on the menu selection screen is reduced. For example, the initial position F is determined such that the operation effort of the user is reduced as compared to a case in which a given initial position is displayed when no face image area has been detected. In particular, the initial position specifying section P2d first retrieves the estimated options 24e in the HDD 24 corresponding to the attribute estimated by the attribute estimating section P2c. If a single estimated option 24e exists, the initial position specifying section P2d determines a position of an option corresponding to the estimated option 24e as the initial position F of the indicator C. If a plurality of the estimated options 24e exists, the initial position specifying section P2d determines a position of an option from which those options corresponding to the estimated options 24e can be accessed with the minimum operation effort as the initial position F.

FIG. 6 shows an exemplary menu selection screen including the initial position F of the indicator C. The initial position F is shown in a language selection screen when the user is estimated to be Asian. In FIG. 6, the indicator C from which the estimated options 24e of the Asian languages can be accessed with the minimum operation effort with the button 50 is presented as the initial position F. Even if the user is estimated to be an Asian, the initial position F is not always placed in any particular position of the estimated options 24e. The initial position F is determined such that the estimated options 24e can be accessed from the initial position F with the minimum operation effort. If there are several positions that can be accessed from the initial position F with the minimum operation effort, any of them can be the initial position F. It should be noted that the language selection screen shown in FIG. 6 presents only several options, and unillustrated options can be displayed by scrolling the menu with the button 50.

The display output section P2e has a function of a display unit for displaying menu selection screens. In particular, the display output section P2e outputs various menu selection screen data including the initial position F specified by the initial position specifying section P2d to the video driver P3, which then causes the screen to be displayed on the display 40.

### (2) Routine for Screen Display Operation

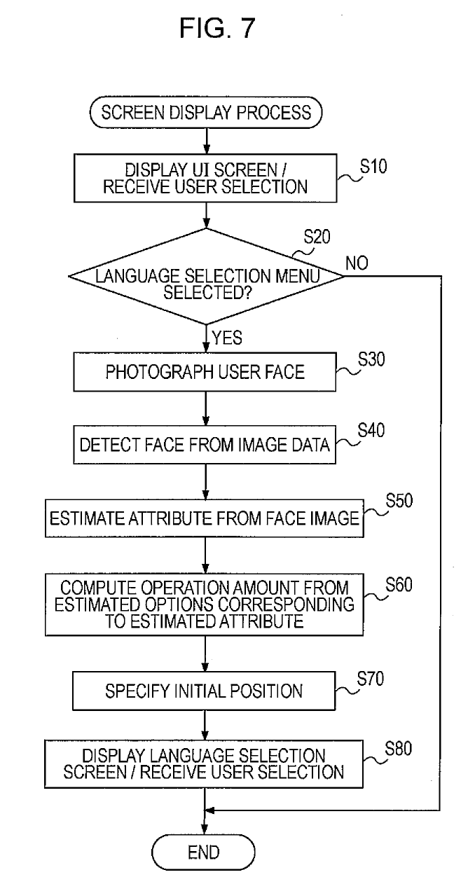

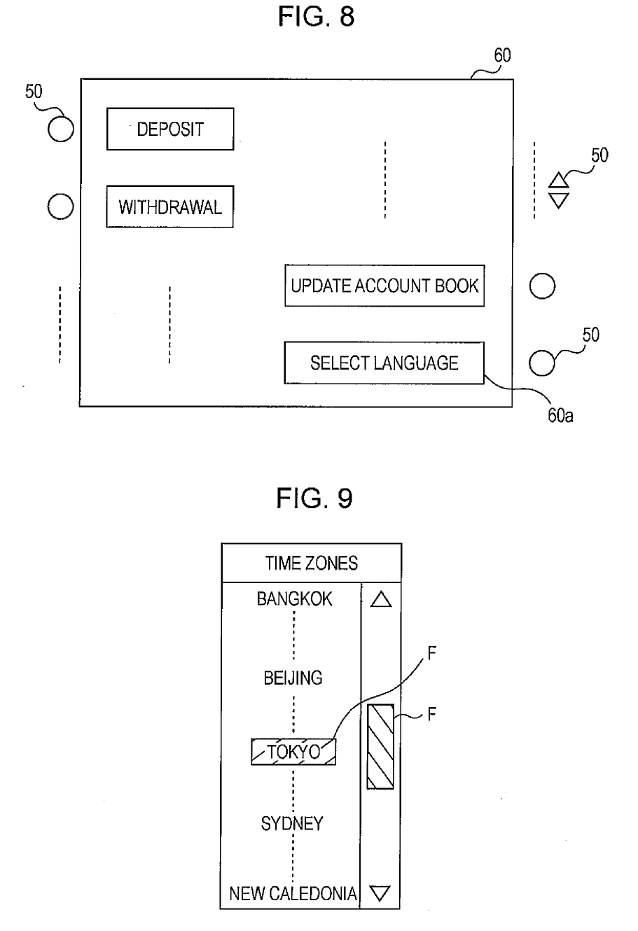

FIG. 7 is a flowchart of a control routine for a screen display process in the computer 20. First, in step S10, a UI screen 60 as shown in FIG. 8 is displayed on the display 40. The UI screen 60 receives user selection regarding an operation menu among various operation menus. In S20, it is determined whether a language selection menu 60a is selected by the user. If negative in S20, i.e., if the user selected none of the operation menus or selected an operation menu other than the language selection menu 60a, the routine is completed. If affirmative in S20, i.e., if the language selection menu 60a is selected, a face image of the user operating the terminal unit 10 is photographed with the camera 30 in S30. In S40, a user face (i.e., facial features) included in the face image data is detected from the photographed user face image data. In S50, the user attribute is estimated from the detected face image. In S60, the estimated options 24e corresponding to the estimated attribute are retrieved from the HDD 24, and an amount of effort to access the indicator C from each of language options corresponding to the estimated options 24e is computed. In S70, a position of a language option which can be accessed with the minimum operation effort is determined as the initial position F. In S80, the language selection screen including the determined initial position F is displayed on the display 40 to receive user selection from the language options. If a single estimated option 24e corresponding to the estimated attribute exists, S60 is skipped and the position of an option corresponding to that estimated option 24e is determined as the initial position F.

In this manner, a suitable initial position is determined for the user to select an option and the user can select an option from a predetermined option group with minimum operation effort. Accordingly, a user interface with improved convenience is provided in which the number of options to be displayed corresponding to the user attribute is not reduced.

### (3) Modified Embodiment

Although the language selection screen in which the initial position is determined in accordance with the user race has been described as the menu selection screen, an aspect of the invention may also be applied to other screens with menu presentation. Other exemplary menu selection screens will be described below.

FIG. 9 shows a screen for selecting a time zone in, for example, a personal computer as a well-known display control device. The initial position is determined in accordance with the user race in this selection screen. For the personal computer, an aspect of the invention may also be applied to, for example, set a screensaver and desktop wallpaper.

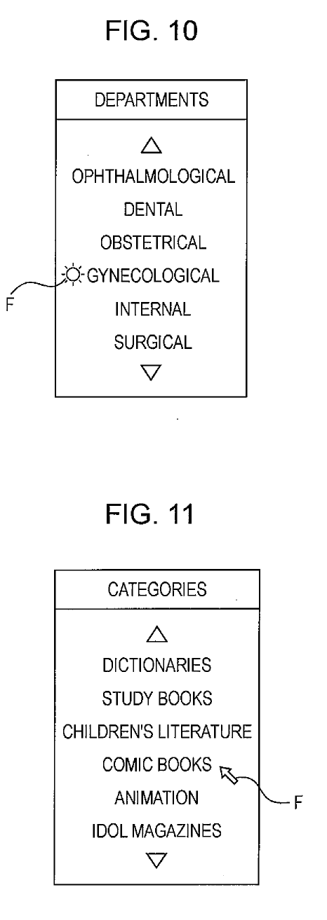

FIG. 10 shows a screen for selecting hospital departments in a guidance display device as a display control device provided in, for example, a hospital. In this selection screen, the initial position is specified in accordance with sex and age of the user.

FIG. 11 shows a screen for selecting book categories in a guidance display device as a display control device provided in, for example, a bookstore. In this selection screen, the initial position is specified according to race, sex and age of the user.

Besides those described above, various devices may be applied to an aspect of the invention as a display control device. For example, the display control device may be a printer with a camera and a well-known mini-laboratory with a camera. The mini-laboratory is often provided in a retail store for developing and printing color films or digital images.

In the described embodiment, the camera 30 is provided for photographing the user and the image data is input to the display control device. The camera, however, is not always necessary and any configuration may be employed to input image data from which a user face image area can be detected. For example, a configuration with input devices, such as a medium reader and a scanner may be employed. Image data may be input through the input devices and a face image may be detected from the input image data. Alternatively, the image data is not necessarily input into the display control device. In this case, the user may select an image stored in the device.

Although the user selection is conducted through operation of the button 50 in the described embodiment, the user selection is not limited thereto. Additionally or alternatively to the operation of the button 50, the user selection may be conducted on a touch panel display 40.

In the described embodiment, the estimated options 24e which may possibly be selected by the user are stored in advance in the HDD 24. Alternatively, the estimated options 24e may be updated through a learning control based on the options actually selected by the user. For example, the language selected by the user may be stored along with the user race. The selected language as well as frequently selected languages may be added to the estimated options 24e. With this configuration, the initial position is determined in a more suitable manner.

The embodiments of the invention have been described in detail with reference to the drawings. Those described, however, are illustrative only and various changes and improvements may be made to an aspect of the invention by those of ordinary skill in the art.

The present application claims the priority based on a Japanese Patent Application No. 2008-079358 filed on Mar. 25, 2008, the disclosure of which is hereby incorporated by reference in its entirety.

What is claimed is:

1. A display control method for displaying a screen which receives a user-selected option from a predetermined option group through predetermined option presentation, the method comprising:
detecting a face image area which at least includes a user face in an image area; and
determining an initial position of the predetermined option presentation in accordance with the face image area.

2. The method according to claim 1, further comprising:
estimating an attribute of the user from the face image area; and
determining the initial position based on the estimated attribute such that the predetermined option presentation is operated by the user through an option-selecting unit with the minimum operating effect in selection of an option.

3. The method according to claim 2, further comprising determining the initial position based on the estimated attribute such that the operation effort of the user is reduced as compared to a case in which a given initial position is displayed when no face image area has been detected.

4. The method according to claim 2, further comprising:
storing, for each attribute, one or more estimated options including predetermined options that may possibly be selected by the user; and
if a single estimated option exists, determining a position of an option corresponding to the estimated option as the initial position, and if a plurality of the estimated options exists, determining a position of an option from which those options corresponding to the estimated options can be accessed with the minimum operation effort as the initial position.

5. The method according to claim 4, further comprising updating the estimated options by learning control based on actually selected options.

6. A display control device for displaying a screen which receives a user-selected option from a predetermined option group through predetermined option presentation, the device comprising:
a face detecting unit for detecting a face image area which at least includes a user face in an image area; and
an initial position specifying unit for determining an initial position of the predetermined option presentation in accordance with the face image area.

7. A display control program to be executed in a computer for displaying a screen which receives a user-selected option from a predetermined option group through predetermined option presentation, the program comprising:
a face detecting function for detecting a face image area which at least includes a user face in an image area; and
an initial position specifying function for determining an initial position of the predetermined option presentation in accordance with the face image area.

8. A printing device comprising:
a display unit for displaying a screen which receives a user-selected option from a predetermined option group through predetermined option presentation;
a face detecting unit for detecting a face image area which at least includes a user face in an image area; and
an initial position specifying unit for determining an initial position of the predetermined option presentation in accordance with the face image area.
